(19) United States
(12) Patent Application Publication
(10) Pub. No.: US 2025/0347175 A1
(43) Pub. Date: Nov. 13, 2025

(54) METHOD AND A SYSTEM FOR DRILLING A RADIAL HOLE IN A TUBULAR STRUCTURE

(71) Applicants: Altus Intervention (Technologies) AS, Stavanger (NO); Baker Hughes Oilfield Operations, LLC, Houston, TX (US)

(72) Inventor: Lukas Haavardsholm, Sandnes (NO)

(21) Appl. No.: 19/197,387

(22) Filed: May 2, 2025

(30) Foreign Application Priority Data
May 7, 2024 (NO) 20240442

(51) Int. Cl. E21B 7/06

(52) U.S. Cl. CPC E21B 7/068

(57) ABSTRACT

A method for drilling a radial hole in a wellbore wall comprising steps of: providing a radial drilling toolstring connected to a surface via an elongated flexible member, the radial drilling toolstring comprises an electronic section, an anchoring portion comprising a primary anchor unit, a drilling portion comprising a radial drill unit, radial drilling toolstring forms a longitudinal axis, radial drill unit adapted to rotate a drill bit and displace and retract the drill bit in a radial direction in relation to the longitudinal axis, electronic section programmable via a graphical user interface and adapted for controlling the radial drilling toolstring to drill the radial hole in the well-bore wall, the GUI comprises visual displays; programming the electronic section with a sequence of actions for the drilling of the radial hole; and activating the electronic section, which drills the radial hole. A radial drilling toolstring is also disclosed.

The invention relates to a method for drilling a radial hole in a tubular structure, which forms part of a wellbore, and a downhole tool for implementing the method.

During any well intervention operations, a main concern at the surface is ensuring the safety of any personnel and equipment. Within the wellbore, the main concern is to avoid damaging any equipment that forms the wellbore or getting a toolstring stuck, as this may lead to a significant downtime in any associated equipment and subsequent production loss from the well. Furthermore, the stuck toolstring may result in expensive salvage or fishing operations.

There are numerous scenarios where it may be beneficial to create a radial hole in the wall of the tubular structure to establish a fluid connection between the interior of the tubular structure and its exterior, such as between a production tubing and an annular space created by a casing that surrounds the production tubing. This may be necessary if the production tubing needs to be removed or replaced, and circulation is required to ensure a homogeneous fluid inside the production tubing and the annular space before the production tubing is replaced or removed. In a deviated part of the wellbore, a portion of the production tubing may be resting on the surrounding casing due to gravity. In these types of scenarios, it might be desirable to create the radial hole upwards where the annular space is larger and, therefore, creates the least fluid restriction for fluid circulation.

Another scenario where the creation of one or more radial holes may be needed is when a clogged filter screen needs to be perforated to restore production, or when a valve is stuck in a closed position. In such cases, it may be desirable to have many closely spaced radial holes to maximize a circulation area within a production zone. Other scenarios may involve injecting cement or glue into the annular space or into a formation surrounding the wellbore, where it might be desirable to have a few large holes spaced in specific orientations.

Another scenario may involve a drill bit drilling a radial hole at a specific direction and being displaced further to cut a communication and/or a control line positioned inside the annular space.

Thus, the radial drilling toolstring, designed for creating one or more radial holes, may need to be adaptable for a variety of scenarios. The radial drilling tool should be configurable with minimal effort, either on the fly while being within the wellbore to accommodate different scenarios, or before being lowered into the wellbore.

It is important that the radial drilling unit is controlled correctly while being downhole. When drilling the radial hole, a drill bit or similar device penetrates the wellbore wall radially. Thus, if a system malfunction or a human error by the operator occurs, the drill bit may jam.

US2012029702AA discloses a machining device for radially machining a tubular component. This machining device comprises an upper and a lower anchor, and a closed-loop control system for managing the movement of the tool member designed to cut into the tubular component.

WO22233933A1 discloses a perforation tool system for radially perforating a screen in a wellbore. This system includes anchors, a first and second tool part, and is designed to perforate multiple radial holes in the screen.

Creating holes by drilling or milling in the radial direction are significantly more complex operations compared to drilling or milling in an axial direction along the wellbore. If an unforeseen event occurs and an axially oriented drill bit jams inside the wellbore, pulling the toolstring towards the exit of the wellbore will straighten the toolstring and promote unjamming the drill bit.

In contrast to axial drilling, any axial or rotational movement of the toolstring during radial drilling may cause the drill bit to jam in the radial hole being created. Any further movement of the toolstring will likely cause the drill bit to become even more jammed. It is crucial to maintain stability for the drill bit to ensure that it drills the radial hole along a straight line radially, allowing the drill bit to drill the hole and then retract without jamming in the hole.

Wellbore intervention operations are often planned with a series of subsequent operations within the same wellbore. Consequently, operators are under pressure to complete the tasks. The operator of the toolstring performing the radial drilling may therefore be under time pressure. Moreover, the toolstring, while downhole, is exposed to challenging environmental conditions such as high temperatures, debris, vibrations, etc., that may cause a toolstring malfunction. The toolstring malfunction may be intermittent or prolonged, both of which may be difficult for the operator under pressure to recognize. The toolstring malfunction may cause unwanted movement in the toolstring, resulting in the drill bit jamming. Furthermore, a human error by the operator while operating the toolstring may cause unintentional movement of the toolstring. None of the prior art provides any means for safeguarding against toolstring malfunction or human errors when the toolstring creates the radial hole.

The invention has for its object to remedy or to reduce at least one of the drawbacks of the prior art, or at least provide a useful alternative to prior art. The object is achieved through features, which are specified in the description below and in the claims that follow. The invention is defined by the independent patent claims. The dependent claims define advantageous embodiments of the invention.

In a first aspect the disclosure relates more particularly to a method for drilling a radial hole in a wellbore wall, the method comprising the steps of:
providing a radial drilling toolstring connected to a surface via an elongated flexible member, the radial drilling toolstring comprises an electronic section, an anchoring portion comprising a primary anchor unit, a drilling portion comprising a radial drill unit, the radial drilling toolstring forms a longitudinal axis, the radial drill unit is adapted to rotate a drill bit and to displace and retract the drill bit in a radial direction in relation to the longitudinal axis, the electronic section is programmable via a graphical user interface (GUI) and adapted for controlling the radial drilling toolstring to drill the radial hole in the wellbore wall, the graphical user interface (GUI) comprises visual displays;
positioning the radial drilling toolstring at a desired position within the wellbore;
programming the electronic section with a sequence of actions for the drilling of the radial hole; and
activating the electronic section, which in turn:
   activates the primary anchor unit to anchor the radial drilling toolstring to the wellbore wall;
   activates the radial drill unit such that the drill bit starts rotating and radially displaces the drill bit to drill the radial hole in the wellbore wall; and
   upon completing drilling the radial hole deactivates the radial drill unit such that the drill bit is retracting into the radial drill unit and the drill bit stops rotating.

The radial drilling toolstring may be a single tool or it may comprise multiple interconnected tools. The longitudinal axis, which may be centrally positioned as a central longitudinal axis, may extend through the radial drilling toolstring from the elongated flexible member to a distal opposite end.

The elongated flexible member, which may be a wireline, a slick line, or coiled tubing, may serve as a communication line between the radial drilling toolstring and the surface. It may also provide the radial drilling toolstring with power, such as electrical power.

The radial hole may range in diameter from 5 millimeters to 50 millimeters, between 9 millimeters and 40 millimeters, and ideally between 12 millimeters and 25 millimeters.

The electronic section may include a central communication module, such as telemetry, that communicates with multiple nodes throughout the radial drilling toolstring. These nodes may be an electronic node card for controlling a hydraulic valve, such as a solenoid- operated hydraulic valve, or for communicating with a sensor, such as a pressure sensor or hall sensor. Alternatively, the node may be a motor controller for controlling an electric motor, or any other suitable node known in the art.

Prior to entry, the electronic section may be connected to the GUI where the sequence of actions may be programmed. Once the radial drilling toolstring has entered the wellbore, the sequence of actions may be performed autonomously based on inputs provided by modules within the radial drilling toolstring, such as a casing collar locator (CCL), a caliper, and/or other modules providing information regarding position and orientation.

In an embodiment, the electronic section may be programmed through the GUI with a pre-planned job profile. This enables the planning of intricate operations, which may include a plurality of radial holes at various desired locations, before dispatching the radial toolstring to the wellsite. Consequently, the operator's role may be simplified to merely receiving the radial drilling toolstring from a base and sluicing it into the wellbore. This approach minimizes the likelihood of human errors. The programming of the electronic section may be handled by a specialist in job-planning and well-planning, while the operator, with their expertise in handling the radial drilling toolstring, may focus on their specific role. This division of tasks ensures that each process is handled by a specialist, thereby enhancing the overall efficiency and accuracy of the operation.

Alternatively, or additionally, the electronic section may include a downhole portion within the radial drilling toolstring and a surface portion. The telemetry, being part of the downhole portion, may be connected to the surface portion via the communication line. The telemetry may be controlled via the GUI by an operator near the wellsite, or alternatively, the operator may be located remotely from the wellsite.

The electronic section is designed to control the radial drilling toolstring such that the sequence of actions may be performed in the programmed sequence. The electronic section may control relevant units, such as the primary anchor unit and the radial drill unit, either through the nodes connected to an actuation means or directly through the telemetry connected to the actuation means for each applicable unit. The actuation means may be an electric motor connected to a hydraulic pump, a solenoid-operated hydraulic valve, an electric motor such as a stepper motor, or any other actuation means for activating an action within the sequence of actions for drilling the radial hole.

The primary anchor unit, located within the anchoring portion, may be configured between an active configuration and a deactivated configuration. In the active configuration, anchoring elements may protrude from a central body of the primary anchor unit such that the anchoring elements may engage with the wellbore wall and anchor the anchoring portion to the internal wellbore wall. In the deactivated configuration, the anchoring elements may not protrude from the main body, meaning the radial drilling toolstring is not anchored to the wellbore wall. The primary anchor unit may anchor the anchoring portion to the wellbore wall such that the anchoring portion is prevented from rotating around the longitudinal axis. Alternatively, or additionally, the primary anchor unit may anchor the anchoring portion to the wellbore wall such that the anchoring portion is prevented from moving in a direction along the longitudinal axis.

In one embodiment, the primary anchor unit may be configured by controlling a solenoid-operated hydraulic valve that controls a fluid flow to and from a hydraulic cylinder. The actuation means in this embodiment may comprise an electric nodeboard for controlling the solenoid-operated hydraulic valve, the solenoid hydraulic valve itself, and the means for providing the hydraulic flow such as a motor-driven hydraulic pump.

In another embodiment, the primary anchor unit may be configured using an electric stepper motor connected to a wedge, or alternatively, an electric motor connected to a screw drive. The actuation means in this case may comprise the motor controller and the electric motor.

The radial drill unit, located in the drilling portion, may be configured between a displaced configuration and a retracted configuration. In the displaced configuration, the drill bit protrudes from a drill unit body of the radial drill unit. In the retracted configuration, the drill bit may not protrude outside the drill unit body.

In an embodiment, the drill bit may be displaced using a hydraulic cylinder, where the actuation means may be an electric card for controlling a solenoid-operated hydraulic valve for controlling a fluid flow to the hydraulic cylinder.

In one embodiment, the drill bit may be displaced using an electric motor connected to a screw drive. The actuation means in this case may comprise a motor controller and the electric motor itself.

In another embodiment, the drill unit may be configured to rotate the drill bit via an electric motor. The actuation means for rotating the drill bit may be a motor controller and the electric motor.

In yet another embodiment, the drill bit may be configured to rotate via a hydraulic motor, where the actuation means may be an electric node card for controlling a solenoid-operated hydraulic valve that regulates fluid flow to the motor.

The radial drill unit may drill the radial hole by rotating the drill bit while displacing the drill bit radially from the longitudinal axis.

The sequence of actions should be performed in a specific order to prevent the drill bit from jamming inside the radial hole. Given the marginal clearance between the radial hole and the drill bit, any minor alteration in the position of the radial drill unit may cause the drill bit to jam. Therefore, the primary anchor unit should remain active whenever the drill bit is in the displaced configuration to ensure the position of the drilling portion is not altered. Due to the known stick-slip effect in the elongated flexible member, combined with gravity, it would be practically impossible to properly align the drill bit with the radial hole if the position of the drill unit is altered while the drill bit is inside the radial hole. By programming the electronic section with the sequence of actions, the probability of human errors is drastically reduced compared to if the operator were to manually perform the sequence of actions in the correct order under time pressure.

In most well intervention operations, there is a period of time from when the radial drilling toolstring is sluiced into the wellbore until it reaches the desired position. This may be a low-stress period that the operator may use to program the electronic section with the sequence of actions. Alternatively, or additionally, the sequence of actions may have been programmed prior to entering the wellbore, and the operator may use this period of time to confirm that the correct sequence of actions has been programmed.

The sequence of actions may include steps such as configuring the primary anchor unit to the active configuration, starting rotation of the drill bit, displacing the drill bit until it has drilled through the wellbore wall, retracting the drill bit back to the retracted configuration, stopping rotation of the drill bit, and configuring the primary anchor unit to the deactivated configuration.

The sequence of actions may include a pause where the operator is required to provide an input via the GUI before the electronic section continues with the sequence of actions. This pause allows the operator to decide whether to abort or continue the sequence of actions. The pause may occur prior to a critical action, such as starting to drill the radial hole, allowing the operator to manually check for any malfunctions in the radial drilling toolstring.

The sequence of actions may be defined as comprising an ongoing action followed by a subsequent action. The electronic section may be programmed such that the subsequent action is performed after a programmed period has elapsed since the start or completion of the ongoing action. The length of the programmed period may depend on the action. For instance, a shorter period may be required to set the primary anchor unit compared to drilling the radial hole. The periods may also depend on the embodiment of the actuation means. For example, when activating the primary anchor unit, a slow-rotating screw drive may take more time compared to a hydraulic piston being filled by a hydraulic pump with a high flow rate relative to the cylinder volume.

The desired position within the wellbore may be any position where one or more radial holes are to be created in the wellbore wall.

The radial drilling toolstring may comprises at least one of a primary anchor sensor and a radial drill unit sensor for measuring a primary anchor performance parameter and/or a radial drill unit performance parameter, respectively.

The method may comprise the step of:
the electronic section performing an automated check during the sequence of actions, the automated check uses at least one of the primary anchor performance parameter and/or a radial drill unit performance parameter.

The configuration of the primary anchor sensor and the primary anchor performance parameter may rely on the design of the primary anchor unit and its actuation mechanism.

In an embodiment where the primary anchor unit operates hydraulically, the primary anchor sensor may be a hydraulic pressure sensor, with the primary anchor performance parameter being the measured hydraulic pressure. This pressure measurement may indicate that the anchoring elements receive adequate hydraulic force from the hydraulic cylinder for secure anchoring to the wellbore wall. Alternatively, or additionally, the electronic node card that powers the solenoid hydraulic valve may serve as the primary anchor sensor, as it may measure if the hydraulic solenoid valve used the expected current during its actuation. The measured current may be defined as the primary anchor performance parameter. If the measured current falls outside a predetermined range, it may suggest a malfunction in the hydraulic solenoid valve, necessitating a halt in the sequence of actions by the electronic section. The electric node board and the hydraulic solenoid valve may be located within the radial drilling toolstring, possibly in a remote position from the primary anchor unit, such as in a hydraulic valve section.

In an embodiment where the primary anchor unit is driven electrically and the actuation mechanism includes the motor controller, the electric motor, and the screw drive, the primary anchor sensor may be the motor controller that measures the motor current used by the electric motor during the configuration of the primary anchor unit. The motor current may be defined as the primary anchor performance parameter. Alternatively, or additionally, the primary anchor sensor may be a linear displacement sensor connected to the screw drive, or it may be a rotation sensor that measures rotations of the screw drive, which may be used to calculate the distance travelled by the screw drive. Thus, the primary anchor performance parameter may be defined as the distance the screw drive has moved the anchoring elements. If the primary anchor performance parameter measured by the motor controller and/or the linear displacement sensor falls outside predetermined ranges or limits, the sequence of actions may need to be halted by the electronic section due to a potential system malfunction.

The radial drill unit sensor may be a linear displacement sensor that measures the displacement of the drill bit in the radial direction. The linear displacement sensor may be a hall sensor, a linear potentiometer, one or two limit switches, or any other suitable sensor known in the field.

In a design where the drill bit is rotated by an electric motor, the radial drill unit performance parameter may be a measured current consumption.

In a design where the drill bit is rotated by a hydraulic motor, the radial drill unit performance parameter may be a measured hydraulic pressure supplied to the motor.

The radial drill unit performance sensor may be a hall sensor designed to measure the rotational speed of the drill bit. Therefore, the rotational speed of the drill bit may be defined as a radial drill unit performance parameter.

The automated check may be performed after at least one of the following actions:
activating the primary anchor unit;
starting rotation of the drill bit;
displacing the drill bit in the radial direction;
retracting the drill bit into the drill unit;
stopping rotation of the drill bit; and
deactivating the primary anchor unit.

In an embodiment, the automated check may be defined as an action within the sequence of actions, for instance, an ongoing action. This automated check may be a system check, where the electronic section examines the system and then either automatically proceeds to the next action or halts the sequence of actions and notifies the operator of a potential equipment malfunction.

As previously noted, programming the electronic section to perform the sequence of actions significantly reduces the likelihood of human errors. By having the electronics section conduct the automated check, a system malfunction may be detected by the electronic section, allowing the sequence of actions to be halted before initiating a subsequent action, or stopping an ongoing action and reconfiguring the radial drill unit back to its retracted configuration. For instance, the radial drill unit may not be activated if the primary anchor sensor and its primary anchor performance parameter indicate a potential malfunction in the primary anchor unit.

In an embodiment, the anchoring portion may be rigidly connected to the drilling portion. This may be applicable for operations where the radial hole(s) need to be positioned at specific locations along a wellbore path. However, as noted, for some operations, it may be desirable to create a plurality of radial holes within a confined space and/or orient the radial holes in relation to the wellbore and a high side.

The radial drilling toolstring may comprise an orientation tool adapted to be controlled by the electronic section, the orientation tool is rigidly connected to the anchoring portion in one end and rigidly connected to the drilling portion in an opposite end, the orientation tool, when activated, is adapted to rotate the drilling portion around the longitudinal axis relative to the anchoring portion. The method may include orienting the drilling portion in relation to the anchoring portion.

The orientation tool, a known device in the field, may comprise a stationary portion and an orientable portion. The orientation tool may be designed to rotate the orientable portion around the longitudinal axis in relation to the stationary portion. The stationary portion may be rigidly connected to, or form part of, the anchoring portion, and the orientable portion may be rigidly connected to, or form part of, the drilling portion. Therefore, by securing the primary anchor unit to the wellbore wall, the orientation tool may rotate the drilling portion around the longitudinal axis, enabling the drill bit to be oriented in relation to the wellbore wall.

The radial drilling toolstring may comprise an orientation tool sensor for measuring an orientation tool performance parameter.

The orientation tool sensor may be positioned within the orientation tool itself, within a remotely positioned device such as the electronic section, the hydraulic valve section, or a combination.

In an embodiment where the orientation tool is operated hydraulically by a hydraulic motor, the orientation tool sensor may be a hydraulic pressure sensor, with the orientation tool performance parameter being the measured hydraulic pressure supplied to the motor. Alternatively, or additionally, the electronic node card that powers a hydraulic solenoid valve for controlling fluid to the motor may serve as the orientation tool sensor, as it may measure if the hydraulic solenoid valve used the expected current during actuation. The measured current may be defined as an orientation tool performance parameter. The hydraulic sensor, the electronic node board, and the hydraulic solenoid valve may be located within the radial drilling toolstring, possibly in a remote position from the orientation tool, such as in the hydraulic valve section.

In an embodiment where the orientation tool is driven electrically and the actuation mechanism includes a motor controller and an electric motor connected to a gearbox, the orientation tool sensor may be the motor controller that measures the motor current used by the electric motor during the operation of the orientation tool. The motor current may be defined as the orientation tool performance parameter.

In an embodiment, the orientation tool sensor may be a rotational sensor that measures the rotation of the orientable portion in relation to the stationary portion. The rotational sensor may be a hall sensor, a resolver, or any other suitable rotational sensor known in the field. The orientation tool performance parameter may therefore be the angular change of the drill bit between a start position and an end position when being oriented. If the orientation performance parameter falls outside a predetermined range, the sequence of actions may need to be halted by the electronic section.

For operations in the deviated part of the wellbore, the orientation tool sensor may be a three-axis accelerometer, a gyroscope, or any other suitable sensors for measuring an orientation in relation to an uppermost high side orientation. Using a watch-face analogy, the high side orientation corresponds to a sector from 9 o'clock to 3 o'clock, and a low side orientation corresponds to a sector from 3 o'clock to 9 o'clock. Therefore, the uppermost high side orientation may be where the drill bit points towards the 12 o'clock position, and the lowermost low side orientation may be towards the 6 o'clock position. Thus, the orientation tool performance parameter may be a measured direction that the drill bit is pointing in.

The method may comprise the step of:
the electronic section performing an automated check during the sequence of actions using the orientation tool performance parameter, the automated check is performed at least one of prior to activating the orientation tool, while the orientation tool is activated, and after deactivating the orientation tool.

The orientation tool performance parameters may be utilized by the electronic section to initiate the subsequent action once the automated check has confirmed that the orientation tool is functioning properly, and the programmed sequence of action is proceeding as planned. For instance, the orientation tool should not be rotating unexpectedly. This may be crucial because displacing the drill bit while the orientation tool is orienting the radial drill unit, or if the drill bit has been oriented unexpectedly, may potentially damage both the drill bit and the wellbore wall.

The orientation tool may be controlled in a timed manner, where it operates for a specific time period to ensure a spacing between the subsequently drilled radial holes. This method may be sufficient for some operations.

The method may comprise the step of:
orienting the drilling portion such that the drill bit is oriented to a programmed orientation in relation to the wellbore before drilling the radial hole in the wellbore wall.

This step may be repeated to provide accurate spacing between radially drilled holes, as the spacing between them may be measured rather than calculated based on time. As a result, the spacing may be reduced, allowing more holes to be drilled within a defined area. For certain operations, such as in the vertical part of the wellbore, the orientation of a subsequently drilled radial hole in relation to a previously drilled radial hole may be more important than the direction in which the radial holes are pointing.

Furthermore, the electronic section may use the orientation tool performance parameters from both the rotational sensor and the three-axis accelerometer to provide accurate spacing between multiple radial holes. Alternatively, or additionally, the orientation tool performance parameters may be used to orient the multiple holes in relation to the high side.

The method may comprise the steps of:
the electronic section comparing the programmed orientation of the drill bit and a measured orientation of the drill bit;
the electronic section using an iterative loop to orient the drill bit to the programmed orientation, and if programmed orientation, during orientation, is overshoot or undershoot the iterative loop uses a measured overshoot or undershoot value between the programmed orientation and the measured orientation during a subsequent attempt to orient the drill bit to the programmed orientation.

In some operations, rotating the drilling portion around the longitudinal axis may require less force compared to other operations where more devices are rigidly connected to the drilling portion. Rotating a heavy toolstring will have more inertia compared to a lighter toolstring when oriented to the programmed orientation. As a result, when orienting the drill bit to the programmed orientation, the orientation tool may overshoot or undershoot the programmed orientation by a value that depends on the specific embodiment of the radial drilling toolstring.

The iterative loop may be a preprogrammed loop that initiates or restarts orientation if the measured orientation of the drill bit falls outside a predetermined range of the programmed orientation. The iterative loop may use a measured overshoot or undershoot to adapt itself for a subsequent attempt to orient the drill bit. Therefore, the iterative loop may be tailored for a specific embodiment of the radial drilling toolstring without intervention of the operator.

The radial drilling toolstring may comprise a linear actuator, the linear actuator is adapted to move the drilling portion along the longitudinal axis in relation to the anchoring portion and may comprise a linear actuator sensor. The method may include displacing the drilling portion in relation to the anchoring portion, the electronic section performing an automated check during the sequence of actions using the linear actuator sensor for measuring a linear actuator performance parameter, the automated check is performed at least one of prior to activating the linear actuator, while the linear actuator is activated, and after deactivating the linear actuator.

The linear actuator may be interconnected with other devices to form the radial drilling toolstring, or it may be integrated into the single tool that may form the radial drilling toolstring.

The linear actuator may be operated hydraulically by a hydraulic piston, or alternatively, it may be electrically operated by a motor controller controlling an electric motor connected to a screw drive.

In an embodiment where the linear actuator is hydraulically operated by the hydraulic piston, a hydraulic solenoid valve may control the fluid flow to and from the hydraulic piston. The linear actuator sensor may be a hydraulic pressure sensor, with the linear actuator performance parameter being the measured hydraulic pressure supplied to the hydraulic piston. Alternatively, or additionally, the electronic node card that powers the solenoid hydraulic valve may serve as the linear actuator sensor, as it may measure if the solenoid hydraulic valve used the expected current during actuation. The measured current may be defined as the linear actuator performance parameter. The electric node board, the hydraulic solenoid valve, and the hydraulic pressure sensor is located within the radial drilling toolstring, possibly in a remote position such as in the hydraulic valve section.

In an embodiment where the linear actuator is electrically operated, the linear actuator sensor may be the motor controller that measures the motor current used by the electric motor during the operation of the linear actuator. The motor current may be defined as the linear actuator performance parameter.

The linear actuator performance parameters may be used by the electronic section to initiate the subsequent action once the automated check has confirmed that the linear actuator is functioning properly, and the programmed sequence of action is proceeding as planned. For instance, the linear actuator should not be moving unexpectedly. This may be crucial because displacing the drill bit while the linear actuator moves the radial drill unit along the longitudinal axis may potentially damage both the drill bit and the wellbore wall.

The radial drilling toolstring may comprise a secondary anchor unit within the drilling portion. The method may include activating the secondary anchor unit prior to drilling the radial hole.

The secondary anchor unit may possess some or all of the same features as the primary anchor unit. As such, the secondary anchor unit may secure the drilling portion to the wellbore wall, preventing the drilling portion from rotating around the longitudinal axis. This may simplify the design of the orientation tool, as the secondary anchor unit may halt any rotation around the longitudinal axis once activated. Alternatively, or additionally, the secondary anchor unit may secure the drilling portion to the wellbore wall in such a way to prevent the drilling portion from moving along the longitudinal axis. This may simplify the design of the linear actuator, as the secondary anchor unit may halt any movement of the drilling portion along the longitudinal axis, once activated. As previously mentioned, the clearance between the radial hole and the drill bit may be minimal. By incorporating the secondary anchor unit and securing it to the wellbore wall, the drill bit is provided with greater stability compared to a radial drilling toolstring that only includes a single anchor, i.e., the primary anchor unit.

The radial drilling toolstring may comprise a secondary anchor sensor. The method may include the electronic section performing an automated check during the sequence of actions using the secondary anchor sensor for measuring a secondary anchor performance parameter, the automated check is performed at least one of prior to activating the secondary anchor unit, while the secondary anchor unit is activated, and after deactivating the secondary anchor unit.

The secondary anchor sensor may possess some or all of the features of the primary anchor sensor. Thus, the secondary anchor performance parameter may be measured and utilized by the radial drilling toolstring in a manner similar to the primary anchor performance parameter.

One effect of the automated check using the secondary anchor performance parameter is that it may prevent operating the orientation tool while the secondary anchor unit is in the active configuration. This may prevent potential damage to the orientation tool and/or the secondary anchor unit, and/or the primary anchor unit, if both the primary and secondary anchor units have been configured to the active configuration before or when the orientation tool is activated.

The primary anchor sensor, the radial drill unit sensor, the orientation sensor, the linear actuator sensor and the secondary anchor sensor each may comprise at least one of an electric sensor, an electronic nodecard, a motor controller, and a hydraulic sensor.

The presence of two or more sensors in a device, such as in the primary anchor unit, allows the electronic section to perform two automated checks to ensure that the device, i.e., the primary anchor unit, is functioning properly. For instance, a first automated check may be performed when the electronic node board measures the current used by the hydraulic solenoid valve when controlling the fluid flow. If the hydraulic solenoid valve malfunctions, the sequence of actions may be halted at this stage. Moreover, if the hydraulic solenoid valve uses the expected current, a second automated check may be performed where the pressure sensor measures a sufficient hydraulic pressure for configuring the primary anchor unit to the active configuration. This may help identify any malfunctions, such as leaking seals or a malfunctioning hydraulic pump.

The electronic section's performance of the first and second automated checks may be applicable to at least one of the primary anchor unit, the radial drill unit, the orientation tool, the linear actuator, and the second anchor section. This “double check” significantly enhances the chances of identifying a system malfunction as early as possible, enabling the electronic section to configure the radial drilling toolstring to a safe configuration, i.e., the drill bit in the retracted configuration.

An operational configuration of the radial drilling toolstring may be defined as any instance when the drill bit is in the displaced configuration.

The electronics section may provide an operator with a status of the automated check(s) via the visual display in the GUI and may stop the sequence of actions if any performance parameter is not within a predetermined limit or range during an action.

Providing the operator with the status of any performed automated check may offer timely information, enabling the operator to decide whether to continue the sequence of actions, i.e., proceed to the subsequent action, or halt the sequence of actions and return the radial drilling toolstring to the safe configuration.

The status may be indicated by a color-coded visual indicator. A green visual indicator may signify a good status, such as when a measured current for an activated hydraulic solenoid valve is within the expected current range. A yellow visual indicator may indicate that the measured current is not within the expected current range. A red light may indicate that the hydraulic solenoid valve is not activated.

If one of the automated checks identifies a performance parameter from any of the devices falling outside its predetermined limit or range while the radial drilling toolstring is in the operational configuration, the electronic section may be programmed to automatically configure the radial drilling toolstring to the safe configuration before handing control back to the operator. This time-critical action by the electronic section may be crucial, for instance, if the hydraulic pressure in the primary anchor unit starts to decrease while drilling the radial hole, leading to diminishing anchoring forces.

Some system malfunctions may not be critical. For example, if the three-axis accelerometer malfunctions while the hall sensor for calculating orientation remains functional, the operator may be informed of the malfunction and may decide to continue the sequence of actions if deemed acceptable.

The method may comprise the steps of:
programming the electronic section to drill at least one subsequent radial hole at a subsequent drill bit position relative to the radial hole;
activating the electric section which in turn:
   positions the drill bit to the subsequent drill bit position; and
   drilling the subsequent radial hole.

The position of the drill bit may include an orientation around the longitudinal axis. Alternatively, or additionally, it may include a position in a direction along the longitudinal axis.

For operations such as perforating a clogged screen with, for instance, fifty radial holes, the positions of these fifty radial holes may be pre-programmed. The electronic section may then reliably execute all the actions with minimal or no intervention from the operator. This automation enhances operational efficiency and accuracy while allowing the operator to monitor the progress.

The radial drilling toolstring may comprises a propulsion device. The method may include moving the radial drilling toolstring to a deviated part of the wellbore using the propulsion device.

The propulsion device may be a drive section, a device well-known in the field of downhole tools. The drive section may be integrated into the single tool that forms the radial drilling toolstring. Alternatively, the drive section may be part of a propulsion tool, such as a wireline tractor, which is also a recognized device in the field. Therefore, the wireline tractor may be a tool within the radial drilling toolstring, which may comprise a plurality of tools.

The method comprises the step of:
providing, through the visual display in the GUI, the orientation of the drill bit in relation to the deviated wellbore and a high side therein.

If a human error occurs while programming the electronic section, the operator, by visually observing the drill bit orientation in a clearly incorrect direction relative to the high side, may have the opportunity to halt the sequence of actions. As previously mentioned, having the operator program the electronic section with the sequence of actions alleviates the need for the operator to perform all the actions manually. This allows the operator to focus solely on monitoring and checking the operation, enhancing the overall efficiency and safety of the drilling process. This is a key advantage of automation in such complex operations.

The electronic section may comprise an inclination sensor. The GUI may provide an indication of the inclination of the radial drilling toolstring, that is, the angle of the wellbore relative to a vertical line at the desired location. This feature enhances the operator's situational awareness by providing a clearer understanding of the position in which they are operating. The inclination data may be utilized to determine when certain sensors, such as the three-axis accelerometer, might not yield reliable readings. This ensures the accuracy and reliability of the operation.

The method may comprise the step of:
programming the electronic section with the sequence of actions where the electronic section, through the GUI and the visual displays, provides information to an operator of at least one of a planned action, a currently ongoing action, and a completed action.

This step reduces the likelihood of human error during the programming of the electronic section, as the drill bit orientation may be clearly visualized in the GUI for at least one of the planned actions, the ongoing action, and the completed action. Consequently, the operator may easily determine if the electronic section is programmed to drill correctly, such as in the high side sector in the deviated part of the wellbore, and/or whether the spacing is sufficient when planning to drill the plurality of radial holes.

Furthermore, if the operator's attention is drawn to an unexpected event, the GUI clearly informs the operator of the progress of the sequence of actions, as the planned action, ongoing action, and completed action are easily identifiable.

As previously mentioned, it is undesirable for the drill bit to jam. Keeping the drill bit sharp enables the radial holes to be drilled with minimal effort, thereby reducing the chances of the drill bit jamming during drilling. Due to the nature of drilling the radial hole in the wellbore wall, the drill bit will initially drill into a concave surface and then drill through a convex surface. The drill bit may include cutting edges, such as cutting segments or integrated cutting edges. Drilling into and out of the concave and convex surfaces implies that the depth of cut varies, which may result in rapid wear of the cutting edges.

The electronic section may be preprogramed to displace and retract the drill bit in a programmed sequence. The programmed sequence may be designed to adjust the weight on the drill bit, e.g., increase, as it drills into the concave surface. This adjustment ensures that the pressure between the cutting edges and the wellbore wall remains within a recommended range, even as the depth of cut changes with rotation.

Moreover, when the drill bit maintains a constant depth of cut, the programmed sequence may provide a steady weight on the drill bit, adhering to the recommended ranges for the specific drill bit in use. As the drill bit begins to penetrate the wellbore wall, i.e., the convex surface, and the depth of cut starts to fluctuate, the programmed sequence may reduce the weight on the drill bit until full penetration is achieved.

Additionally, testing has demonstrated that rotating the drill bit while it is situated inside the newly drilled radial hole facilitates its retraction into the radial drill unit. The method may comprise the step of:
programming the electronic section to displace the drill bit out to a specific distance in the radial direction.

This mechanism allows the operator to prevent the drill bit from being displaced too far outward, thereby ensuring that the drill bit does not damage any equipment positioned adjacent to or near the convex surface when drilling through the wellbore wall.

As previously mentioned, the success of the drilling operation is paramount, and it is crucial to prevent the drill bit from jamming in the wellbore wall. Tests may indicate that a drill bit is capable of safely drilling a specific number of radial holes in the wellbore wall when the wall is composed of a particular material. The specific number of radial holes may depend on the type of drill bit used and the material of the wellbore wall. If a worn drill bit is used to drill a radial hole, it may jam or cause unnecessary wear on the radial drilling toolstring.

The electronic section may monitor a drill bit performance parameter. This monitoring may include automatically counting the number of radial holes drilled with a specific drill bit. Alternatively, or in addition, the drill bit performance parameter may be monitored by comparing the measured time used to drill a radial hole with a predetermined limit for safe drilling. For instance, if the drill bit takes too long to drill a hole, this may indicate that the bit is worn. The electronic section may be adapted to return the radial drilling toolstring to the safe configuration while alerting the operator that the drill bit is not performing within the predetermined limit.

Safety is of utmost importance. It is standard practice to have an emergency stop button so that any ongoing wellbore operation may be halted immediately if an unforeseen situation arises. If an unforeseen situation occurs, pressing the emergency stop button and cutting power to the radial drilling toolstring while drilling may cause the bit to jam. It may be crucial that the drill bit is retracted while the radial drilling toolstring is anchored to the wellbore wall such that an even more critical situation may be prevented. The GUI may provide the operator with a “Stop drilling” visual button in the GUI, the “Stop drilling” button may be adapted to program the electronic section with a stop-drilling sequence of actions to deactivate the radial drill unit such that the drill bit is retracted to a stored position and rotation of the drill bit is stopped while at least the primary anchor unit remains active. When the “Stop drilling” button in the Graphical User Interface (GUI) is activated, the radial drilling toolstring may first be returned to a safe configuration before the power supply is disconnected. This procedure ensures the safety of the operation and prevents potential damage to the equipment and an even more severe situation.

In an embodiment, pressing the “Stop drilling” button may solely revert the radial drill unit to the safe configuration. It may not deactivate the primary anchor unit, thereby providing the operator with the option to resume the drilling operation. This feature ensures that the orientation of the drilling portion remains consistent with an already drilled radial hole, preventing any compromise in alignment.

The orientation tool may be adapted to controllably orient the radial drill unit in 360 degrees around the longitudinal axis. Thus, the orientation of the drill bit may be adjusted according to any specific operation being conducted. Consequently, a single radial drilling toolstring may be adapted to accommodate a majority of radial drilling operations.

The following sequence of actions is an example for a preferred embodiment of the radial drilling toolstring, which features hydraulically operated anchors, hydraulically displacement of the drill bit, and electrical rotation of the drill bit. After the radial drilling toolstring may have been inserted into the wellbore and may have reached the desired position for drilling the radial holes within the wellbore, the subsequent steps may be executed by the electronic section:

### Initial and Continuous Check

Verify the operational status of the Hydraulic Power Unit (HPU) comprising the hydraulic valve section.

### Activation of the Primary Anchor Unit

Activate the primary anchor unit.

Confirm that the current consumption for operating the hydraulic solenoid valve for controlling fluid flow to the primary anchor unit is within a predetermined and expected range.

Confirm that the hydraulic pressure for activating the primary anchor unit is within a specified range to guarantee sufficient anchoring force. This hydraulic pressure may be continuously monitored until the primary anchor unit is selectively deactivated.

### Checking and Orienting the Radial Drill Unit

Assess the measured orientation of the radial drill unit relative to the programmed orientation. The orientations may be measured relative to a high side within the wellbore.

If the measured orientation is within a predetermined range of the programmed orientation, proceed to activate the secondary anchor unit.

If the measured orientation is outside the predetermined range, activate the orientation tool.

Confirm the activation of the orientation tool by measuring the current consumption while activating the hydraulic solenoid valve for operating a hydraulic motor adapted for rotating the orientable portion.

Verify that the orientation sensor, in the form of a three-axis accelerometer, is operational and approaching the programmed orientation.

At an expected overshoot or undershoot value, deactivate the orientation tool.

Compare the measured orientation with the programmed orientation of the drill bit.

If the measured orientation is within the predetermined orientation range, proceed to activate the secondary anchor unit.

If the measured orientation is outside the predetermined range, measure the overshoot or the undershoot between the measured orientation and the programmed orientation.

Repeat the steps to orient the radial drill unit using the measured overshoot or undershoot. This may ensure that the radial drill unit may stop at the programmed orientation with minimum overshoot or undershoot in the subsequent attempt to orient the drill bit.

Compare the measured orientation with the programmed orientation.

If the measured orientation is within the predetermined orientation range, proceed to activate the secondary anchor unit.

If the measured orientation is outside the predetermined range, perform the steps to orient using the latest measured over or undershoot value.

### Activation of the Secondary Anchor Unit

Once the radial drill unit is oriented within the programmed orientation range, activate the secondary anchor unit.

Confirm that the measured current consumption for operating the hydraulic solenoid valve for controlling fluid to the secondary anchor unit is within a predetermined and expected range.

Ensure that the hydraulic pressure for activating the secondary anchor unit is within a predetermined range to guarantee sufficient anchoring force. This hydraulic pressure may be continuously monitored until the secondary anchor unit is selectively deactivated.

### Drilling the Radial Hole

Activate the rotation of the drill bit.

Verify that the current consumption for the electric motor, which rotates the drill bit, is within a predetermined range to ensure proper operation.

Confirm that the rotational speed of the drill bit is within the predetermined range.

Activate the hydraulic solenoid valve to displace the drill bit radially out from the longitudinal axis.

Check that the measured current consumption for operating the hydraulic solenoid valve for displacing the radial drill bit is within a predetermined and expected range.

While drilling, check that the drill bit drills the radial hole within a predetermined time.

Ensure that the hydraulic pressure sensor measuring hydraulic pressure for displacing the drill bit increases to within a predetermined range.

Verify with a displacement sensor that the drill bit is displaced out.

Confirm that the current consumption for the electric motor for the drill bit is within the predetermined ranges while milling such that safe drilling is ensured.

Verify that the drill bit penetrates the wellbore wall by measuring the current consumption while drilling the radial hole. A decrease in the current consumption indicates that the drill bit may have penetrated the wellbore wall.

Operate the hydraulic solenoid valve to retract the drill bit.

Confirm that the measured current consumption for operating the hydraulic solenoid valve for retracting the radial drill bit is within a predetermined and expected range.

Verify with the displacement sensor that the drill bit is retracting.

After the drill bit is measured to be fully retracted, confirm that the hydraulic pressure for retracting the drill bit is within a predetermined range such that sufficient retraction force is assured.

The bit retraction hydraulic pressure may be continuously monitored such that the drill bit is not accidently displaced out.

### Deactivation of the Secondary Anchor Unit

Deactivate the secondary anchor unit.

Confirm that the measured current consumption for operating the hydraulic solenoid valve for deactivating the secondary anchor unit is within a predetermined and expected range.

Ensure that the hydraulic pressure for the secondary anchor unit decreases to below a predetermined limit such that the secondary anchor unit does not provide anchoring force.

If a plurality of radial holes is programmed, continue with the steps from “Checking and Orienting the Radial Drill Unit” for drilling a subsequent radial hole.

Certain steps within the method may be deemed non-essential and subsequently omitted. Conversely, additional steps may be incorporated to augment the method's capabilities. For instance, after drilling a plurality of holes in an axial position along the wellbore, the linear actuator may be employed to relocate the radial drill unit to a subsequent axial position along the wellbore. This may precede the drilling of the plurality of oriented radial holes in the subsequent axial position.

In a reperforation operation of a blocked screen, it may be necessary to drill e.g., fifty radial holes. Consequently, the aforementioned steps for drilling multiple holes may be repeated fifty times. It is well-known that repetitive tasks performed by an operator may lead to complacency, which in turn may result in human error or undetected system malfunctions. The automation associated with the first aspect of the invention surpasses the efficiency of manually operated systems, significantly reducing or eliminating human errors and issues related to late-discovered system malfunctions.

The electronics section may be programmed to execute any actions based on telemetry data commands created downhole, allowing for a quicker response time compared to a command processed and sent from the surface portion of the electronic section, such as when responding to a measured performance parameter within the radial drilling toolstring. Alternatively, or additionally, the electronics section may be programmed to execute any actions from the surface portion of the electronics section. This may allow better control for the operator, such as when the operator needs to halt an action due to an unforeseen occurrence.

In a second aspect the invention relates more particularly to a radial drilling toolstring for drilling a radial hole in a wellbore wall, the radial drilling toolstring is adapted to connect to a surface via an elongated flexible member, the radial drilling toolstring forms a longitudinal axis, wherein:
the radial drilling toolstring comprises an electronic section, an anchoring portion comprising a primary anchor unit, and a drilling portion comprising a radial drill unit;
the radial drill unit is adapted to rotate a drill bit and to displace and retract the drill bit in a radial direction in relation to the longitudinal axis;
the electronic section is programmable with a sequence of actions via a graphical user interface (GUI) and adapted for controlling the radial drilling toolstring to drill the radial hole in the wellbore wall;
the electronic section being adapted to perform an automated check of a primary anchor performance parameter while performing the sequence of actions and either continue or stop the sequence of actions if the primary anchor performance parameter does not meet set ranges or limits; and - a primary anchor sensor is connected to the primary anchor unit for measuring the primary anchor performance parameter.

The radial drilling toolstring in the second aspect of the invention may possess some or all of the features of the radial drilling toolstring in the first aspect. These features will therefore not be described again. Further, the radial drilling toolstring in the first aspect of the invention may possess some or all of the features of the radial drilling toolstring in the second aspect.

The radial drilling toolstring may comprise at least two radial drill unit sensors connected to the radial drill unit for measuring at least one drill unit performance parameter.

During the relocation of the radial drilling toolstring within the wellbore, it may be crucial that the radial drill unit is maintained in the retracted configuration. This precautionary measure prevents the drill bit from causing damage to the wellbore equipment. Furthermore, the incorporation of two sensors in the radial drill unit ensures redundancy, thereby enhancing the reliability and safety of the operation.

The radial drilling toolstring may comprise an orientation tool adapted to be controlled by the electronic section, the orientation tool is rigidly connected to the anchoring portion in one end and rigidly connected to the drilling portion in an opposite end, when activated, the orientation tool is adapted to rotate the drilling portion around the longitudinal axis relative to the anchoring portion.

The radial drilling toolstring may comprise an orientation tool sensor for measuring an orientation tool performance parameter.

The radial drilling toolstring may comprise a linear actuator adapted to be controlled by the electronic section, the linear actuator is adapted to move the drilling portion along the longitudinal axis in relation to the anchoring portion.

The radial drilling toolstring may comprise a linear actuator sensor for measuring a linear actuator performance parameter.

The radial drilling toolstring may comprise a secondary anchor unit rigidly connected in the drilling portion. The secondary anchor unit may be adapted to be controlled by the electronic section.

The radial drilling toolstring may comprise a secondary anchor sensor for measuring a secondary anchor performance parameter.

In the following is described examples of preferred embodiments illustrated in the accompanying drawings, wherein:

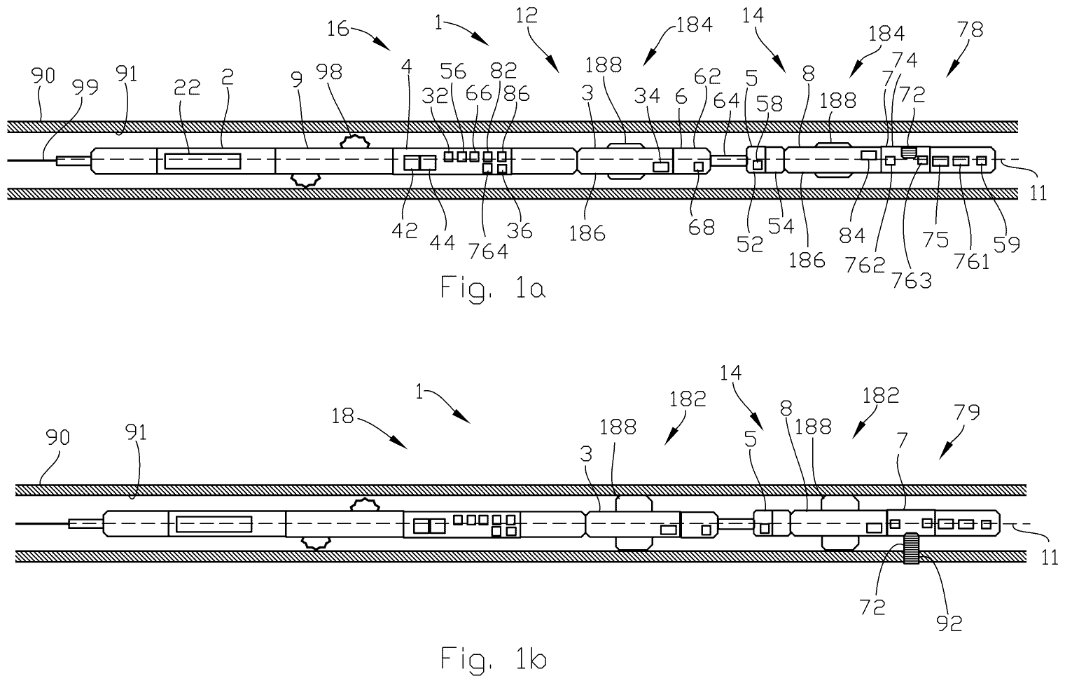

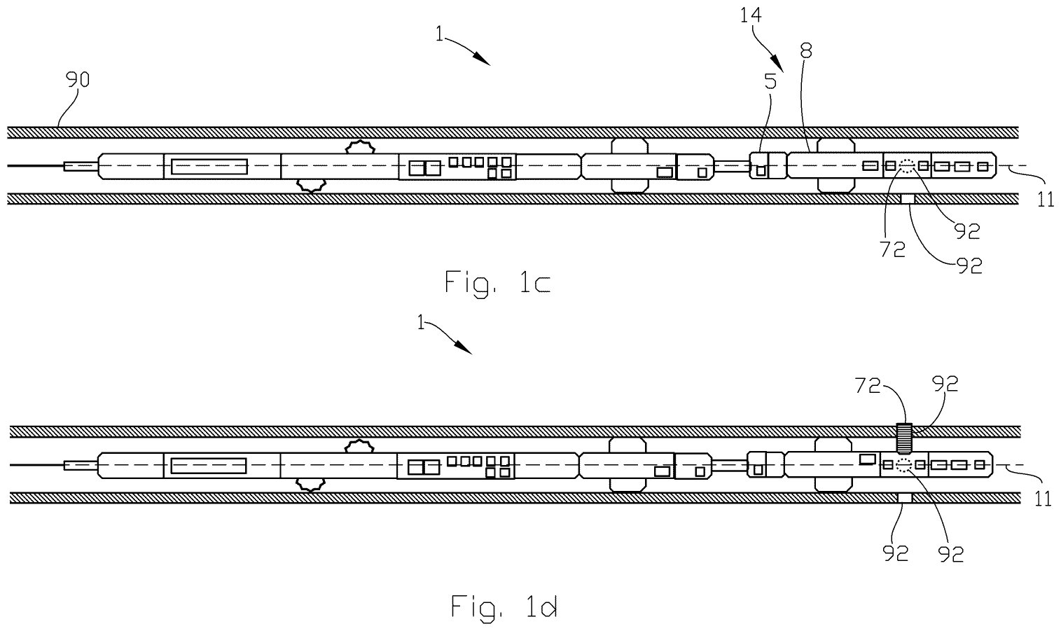

FIG. 1a shows, from a sideview, a radial drilling toolstring being conveyed to a desired position within a deviated part of a wellbore by a propulsion device;

FIGS. 1b-d show the radial drilling toolstring being anchored to a wellbore wall and drilling a plurality of radial holes;

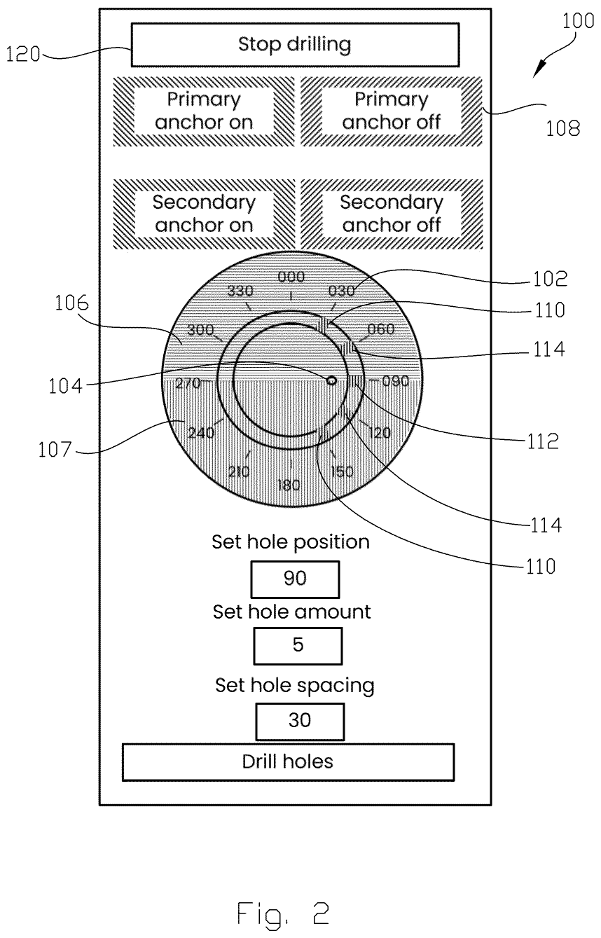

FIG. 2 shows a GUI for communicating with the radial drilling toolstring;

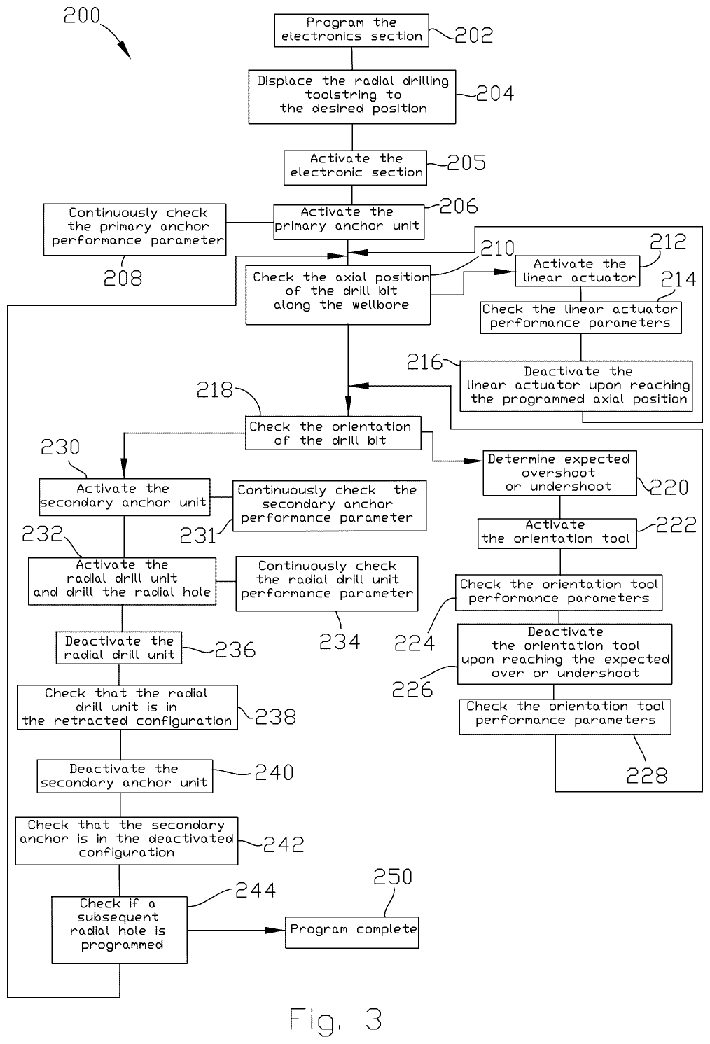

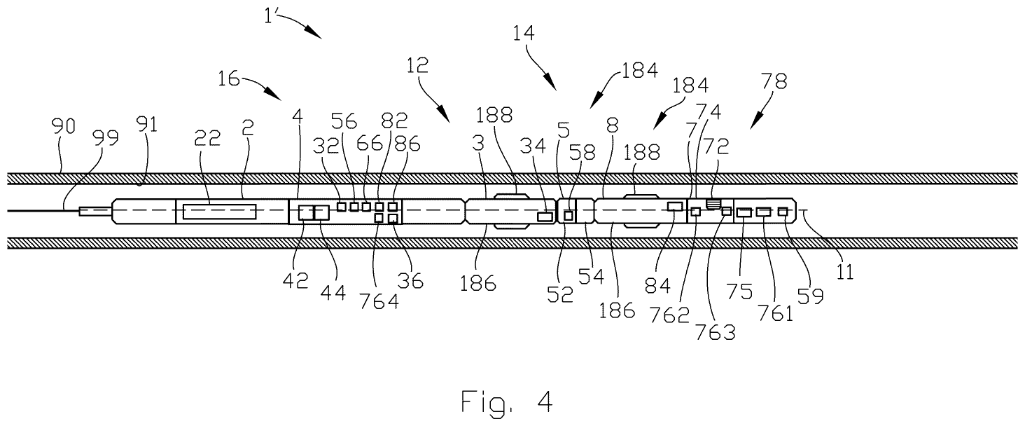

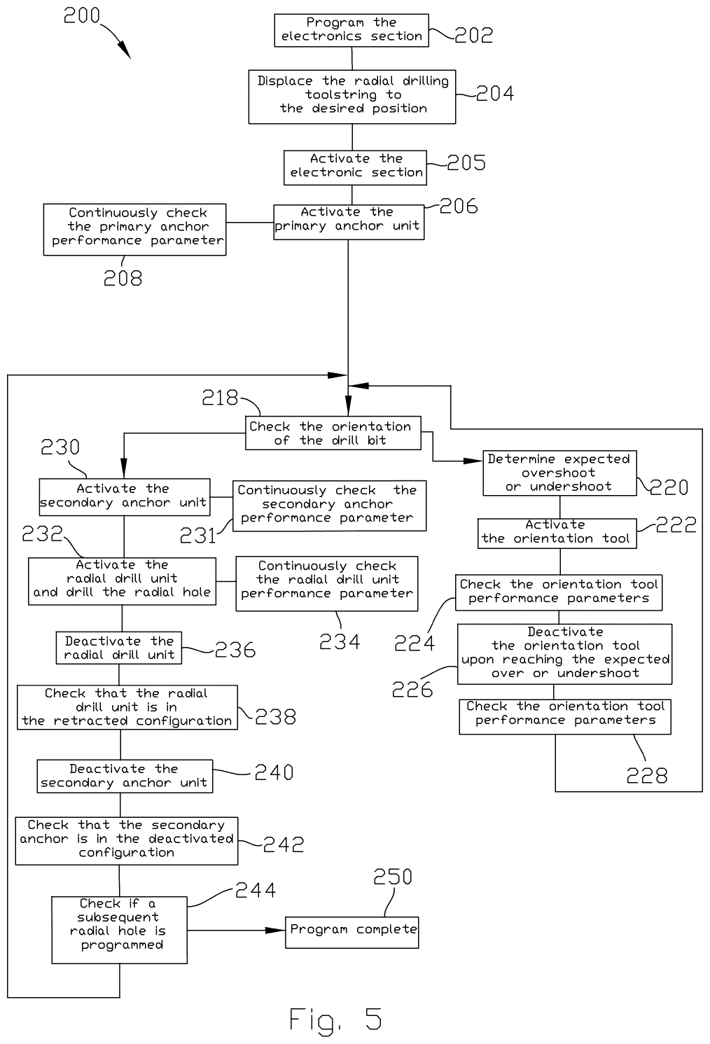

FIG. 3 shows a method for drilling a radial hole using the radial drilling toolstring;

FIG. 4 shows, from a sideview, an alternative embodiment of the radial drilling toolstring; and

FIG. 5. shows an alternative method for drilling a radial hole in the wellbore wall.

Any positional indications refer to the position shown in the figures. In the figures, same or corresponding elements are indicated by same reference numerals. For clarity reasons, some elements may in some of the figures be without reference numerals.

A person skilled in the art will understand that the figures are just principal drawings. The relative proportions of individual elements may also be distorted.

FIG. 1a shows a radial drilling toolstring 1 positioned at a desired location within a deviated section of a wellbore 90. The radial drilling toolstring 1 is connected to the surface via an elongated flexible member, referred to as a wireline 99. The wireline 99 supplies power and facilitates communication between a surface equipment (not shown) and the radial drilling toolstring 1. The radial drilling toolstring 1 forms a longitudinal axis 11 extending from the connection point of the wireline 99 to a distal opposite end of the radial drilling toolstring 1.

The radial drilling toolstring 1 includes an electronic section 2 comprising a telemetry system 22. The telemetry system 22 is wired and configured to communicate with and control nodes within the radial drilling toolstring 1. Further details on this will be provided later in the description.

The electronic section 2 may be programmed via a graphical user interface (GUI) 100 (as seen in FIG. 2) and is designed to control the controllable devices that form the radial drilling toolstring 1. The electronic section 2 may be programmed with a sequence of actions 200, allowing the operator to monitor the radial drilling toolstring 1 as it performs the sequence of actions 200 to drill one or more radial holes 92 (see FIGS. 1b-1d). Detailed descriptions of the GUI 100 and the sequence of actions 200 will be provided in relation to FIGS. 2 and 3, respectively.

A propulsion device, referred to as a tractor 9, is designed to grip the internal wellbore wall 91 using selectively rotatable rollers 98 and to propel the radial drilling toolstring 1 to the desired position within the wellbore 90 where it is desirable to drill the radial hole 92 (as seen in FIGS. 1b-1d. The tractor 9 is connected at one end to the electronic section 2 and at the opposite end to a hydraulic power unit (HPU) 4

The HPU 4 comprises an electric motor 42, a hydraulic pump 44, multiple hydraulic pressure sensors, and several hydraulic valves, i.e., a hydraulic valve section. These components control fluid flow across various hydraulic circuits. Further details about the HPU 4 will be discussed later in the description.

The primary anchor unit 3 may be configured between an active configuration 182 as depicted in FIG. 1b, and a deactivated configuration 184 as seen in FIG. 1a. In the active configuration 182, a plurality of anchoring members 188 extend from a central body 186 and grip the internal wellbore wall 91. The primary anchor unit 3 comprises three primary anchor sensors: a first primary anchor sensor 32 located in the HPU 4, a second primary anchor sensor 34 located in the primary anchor unit 3, and a third primary anchor sensor 36 also located in the HPU 4. The first primary anchor sensor 32 is an electric solenoid drive board designed to control and measure current consumption to a hydraulic solenoid valve, which controls fluid flow to and from the primary anchor unit 3. The second primary anchor sensor 34 is a displacement sensor within the primary anchor unit 3 that measures the displacement of the anchoring members 188. The third primary anchor sensor 36 is a pressure sensor that measures a hydraulic force exerted on the hydraulic piston. Although the first primary anchor sensor 32 and the third primary anchor sensor 36 may be easily positioned within the primary anchor unit 3, the depicted embodiment shows that the primary anchor sensors 32, 34, 36 need not be located within the primary anchor unit 3 or in close proximity to each other.

The primary anchor unit 3 is firmly connected to a linear actuator 6. The linear actuator 6 comprises a rigid portion 62 firmly connected to the primary anchor unit 3, and a movable portion 64 connected to an orientation tool 5. The linear actuator 6 is designed to move the movable portion 64 and any connected parts, such as the orientation tool 5, along the longitudinal axis 11. The linear actuator 6 comprises two sensors: a first linear actuator sensor 66 located in the HPU 4, and a second linear actuator sensor 68 located within the linear actuator 6. The first linear actuator sensor 66 is a hydraulic pressure sensor that measures the hydraulic pressure used to actuate the linear actuator 6. The second linear actuator sensor 68 is a linear position sensor designed to measure movement between the rigid portion 62 and the movable portion 64.

The orientation tool 5 comprises a stationary portion 52 firmly connected to the movable portion 64 of the linear actuator 6, and an orientable portion 54 firmly connected to a secondary anchor unit 8. The orientation tool 5 is designed to controllably rotate the orientable portion 54 around the longitudinal axis 11, allowing the secondary anchor unit 8 and any firmly connected devices to be oriented around the longitudinal axis 11. The orientation tool 5 includes three sensors: a first orientation tool sensor 56 located in the HPU 4, a second orientation tool sensor 58 located within the orientation tool 5, and a third orientation tool sensor 59 located within a radial drill unit 7. The first orientation tool sensor 56 is a pressure sensor that measures the hydraulic pressure supplied to the orientation tool 5 for rotating the orientable portion 54. The second orientation tool sensor 58 is a hall sensor that measures the rotational speed between the stationary portion 52 and the orientable portion 54. The third orientation tool sensor 59 is a three-axis accelerometer sensor that measures the orientation of the radial drill unit 7 relative to a high side within the deviated part of the wellbore 90. Using a watch-face analogy, the high side orientation corresponds to a sector from 9 o'clock to 3 o'clock, and a low side orientation corresponds to a sector from 3 o'clock to 9 o'clock. The uppermost high side orientation is where a drill bit 72 within the radial drill unit 7 points towards the 12 o'clock position, and the lowermost low side orientation is towards the 6 o'clock position. The radial drill unit 7 will be described later.

The secondary anchor unit 8 is similar to the primary anchor unit 3, comprising a central body 186 and anchoring members 188. Like the primary anchor unit 3, the secondary anchor unit 8 may be configured between the active configuration 182 and the deactivated configuration 184. The secondary anchor unit 8 comprises three sensors: a first secondary anchor sensor 82 located in the HPU 4, a second secondary anchor sensor 84 located in the secondary anchor unit 8, and a third secondary anchor sensor 86 also located within the HPU 4. The first secondary anchor sensor 82 is an electric solenoid drive board designed to control and measure current consumption to a hydraulic solenoid valve, which controls fluid flow to and from the secondary anchor unit 8. The second secondary anchor sensor 84 is a displacement sensor positioned within the secondary anchor unit 8 that measures the displacement of the anchoring members 188. The third secondary anchor sensor 86 is a pressure sensor that measures the force exerted on the hydraulic piston for providing force to activate or deactivate the secondary anchor unit 8.

The secondary anchor unit 8 is firmly connected to the radial drill unit 7, which comprises the drill bit 72. The radial drill unit 7 is designed to rotate the drill bit 72 using an electric motor 75. Moreover, the radial drill unit 7 may be configured between a displaced configuration 79, where the drill bit 72 projects radially out of a drill unit body 74, and a retracted configuration 78, where the drill bit 72 is retracted into the drill unit body 74. The extension and retraction of the drill bit 72 are controlled by a hydraulic piston (not shown). The radial drill unit 7 includes four sensors. A first radial drill unit sensor 761 is a motor controller for the electric motor 75. A second radial drill unit sensor 762 is a hall sensor positioned near the electric motor 75 to measure a rotational speed of the drill bit 72. A third radial drill unit sensor 763 is a displacement sensor designed to measure the radial displacement of the drill bit 72 relative to the longitudinal axis 11. A fourth radial drill unit sensor 764 is a hydraulic pressure sensor located in the HPU 4 designed to measure the force created by the hydraulic piston displacing the drill bit 72 radially, thereby measuring the drill bit displacement force, e.g., a weight on bit force. The previously mentioned third orientation tool sensor 59 has a fixed position relative to the drill bit 72, allowing the orientation tool 5 to orient the drill bit 72 relative to any orientation within the wellbore 90 such as the uppermost high side orientation.

The radial drilling toolstring 1 comprises an anchoring portion 12 and a drilling portion 14. The anchoring portion 12 comprises the primary anchor unit 3, the linear actuator 6 and the orientation tool 5. When in the active configuration 182, the primary anchor unit 3 firmly anchors the anchoring portion 12 to the internal wellbore wall 91 in both a direction around the longitudinal axis 11 and along the longitudinal axis 11. The drilling portion 14 comprises the secondary anchor unit 8, and the radial drill unit 7. The secondary anchor unit 8 firmly anchors the drilling portion 14 to the internal wellbore wall 91 in both the direction around the longitudinal axis 11 and along the longitudinal axis 11. This dual-anchor setup provides the drill bit 72 with enhanced stability compared to an embodiment with one anchor only, enabling it to drill the radial hole 92 with minimal risk of jamming.

FIG. 1a shows the radial toolstring 1 in a safe configuration 16, where the radial drill unit 7 is in the retracted configuration 78. This means the drill bit 72 is retracted within the drill unit body 74, eliminating the risk of the drill bit 72 catching a profile within the wellbore 90 and causing the radial drilling toolstring 1 to jam in the wellbore 90.

FIG. 1b shows the radial drilling toolstring 1 in an operational configuration 18, where the radial drill unit 7 is in the displaced configuration 79 and both the primary anchor unit 3 and the secondary anchor unit 8 secure the radial drilling toolstring 1 to the internal wellbore wall 91. The radial drilling toolstring 1 has drilled one radial hole 92 at the 6 o'clock position. This was achieved by activating the primary anchor unit 3, orienting the drilling portion 14 so that the drill bit 72 points towards the lowermost low side orientation (i.e., the 6 o'clock position), activating the secondary anchor unit 8, and then rotating and radially displacing the drill bit 72 outward relative to the longitudinal axis 11. FIG. 1c shows the radial drilling toolstring 1 having drilled a radial hole 92 at the 9 o'clock position within the wellbore 90. This was accomplished by deactivating the secondary anchor unit 8 after drilling the first radial hole 92 at the 6 o'clock position, orienting the drilling portion 14 using the orientation tool 5, activating the secondary anchor unit 8, and then drilling the radial hole 92 at the 9 o'clock position using the radial drill bit 72.

FIG. 1d illustrates the radial drilling toolstring 1 having drilled a radial hole at the 12 o'clock position, i.e., the uppermost high side position within the wellbore 90. This was done in a similar manner to the process described in relation to FIG. 1c, but with the drill bit 72 oriented to the 12 o'clock position.

The electronics section 2 was programmed with a sequence of actions 200 for drilling the three radial holes 92 before entering the wellbore 90. As a result, an operator (not shown) only needed to monitor the sequence of actions 200 while the radial holes 92 were being drilled.

FIG. 2 shows the Graphical User Interface (GUI) 100, which is designed to program and control the electronics section 2. The GUI 100 includes a 360-degree arc 102 that indicates a high side sector 106 and a low side sector 107. Using the watch-face analogy, the high side sector 106 corresponds to a sector from 9 o'clock to 3 o'clock, and the low side sector 107 corresponds to a sector from 3 o'clock to 9 o'clock. The high side sector 106 is defined as a sector being located higher than the low side sector 107 within the wellbore 90.

The 360-degree arc 102 provides information about the orientation of the drill bit 72 via a drill bit indicator 104 and its position relative to the 12 o'clock position when within the wellbore 90. For instance, the drill bit indicator 104 positioned in a 090 indication means the drill bit 72 points towards the 3 o'clock position, a 180 indication means the drill bit points towards the 6 o'clock position, and so on. In FIG. 2, the drill bit indicator 104 shows that the drill bit 72 is pointing towards 090, i.e., 90 degrees relative to the 12 o'clock position.

The GUI 100 comprises displays of a planned action 110 marked at the 030 and 150 directions, an ongoing action 112 indicated at the 090 direction, and a completed action 114 at the 060 and 120 directions. This makes it intuitive and easy for the operator to identify human errors or system malfunctions while the sequence of action 200 is ongoing.

Furthermore, the GUI 100 comprises a plurality of status indicators 108 that show the status of the primary anchor unit 3 and the secondary anchor unit 8.

The GUI comprises a “stop drilling” button 120 which is designed such that the electronic section 2 is programmed with a sequence of actions 200 to configure the radial drilling toolstring to the safe configuration 16, when pressed.

FIG. 3 illustrates a method and the sequence of actions 200 that may be programmed into the electronics section 2 to enable the radial drilling toolstring 1 to drill one or more radial holes 92 without operator intervention. The method comprises several steps, and it should be understood that some steps may be added or removed without deviating from the scope of the invention.

In a step 202, the electronic section 2 is programmed with the sequence of actions 200. In a step 204, the radial drilling toolstring 1 is displaced within the wellbore 90 to the desired position. In a step 206, the primary anchor unit 3 is activated. In a step 208, the primary anchor sensors 32, 34, 36 and their respective primary anchor performance parameters are continuously monitored until the primary anchor unit 3 is selectively deactivated. If any primary anchor performance parameter falls outside a predetermined range, the electronic section 2 programs the radial drilling string 1 to the safe configuration 16.

In a step 210, the axial position of the radial drill unit 7 along the longitudinal axis 11 is checked. If the axial position is outside a predetermined range, the method proceeds to a step 212. If the axial position is within a predetermined range, the method proceeds to a step 218.

The step 212 comprises activating the linear actuator 6. A step 214 comprises checking the performance parameters of the linear actuator sensors 66, 68. A step 216 comprises deactivating the linear actuator 6 upon reaching the programmed axial position. The step 210 is then performed again to check that the new axial position is within the predetermined range.

As mentioned, once the measured axial position is within the predetermined range, the step 218 is performed. The step 218 comprises checking that a measured orientation of the drill bit 72 around the longitudinal axis 11 is within a predetermined range. If the measured orientation is outside a predetermined range, a step 220 is performed. If the measured orientation is within the predetermined range, a step 230 is performed. The step 220 comprises determining an expected overshoot or undershoot value. The overshoot or undershoot value is due to inertia from the drilling portion 14 being rotated around the longitudinal axis 11 and may vary depending on the embodiment of the radial drilling toolstring 1. The expected overshoot or undershoot value may be a calculated value between a programmed orientation and a measured orientation after the orientation tool 5 has been operated. Alternatively, or additionally, the expected overshoot or undershoot value may be input by the operator. A step 222 comprises activating the orientation tool 5, followed by a step 224 to monitor the orientation tool performance parameters measured by the orientation tool sensors 56, 58, 59.

A step 226 comprises deactivating the orientation tool 5 once the expected overshoot or undershoot value is reached. A step 228 comprises checking the performance parameters of the orientation tool 5 to ensure that the orientable portion 54 has stopped rotating. A step 218 is then repeated to compare the measured orientation with the programmed orientation.

Once the measured orientation is within the predetermined range, a step 230 is performed, which comprises activating the secondary anchor unit 8. A step 231 comprises checking and monitoring the secondary anchor performance parameters measured by the secondary anchor sensors 82, 84, 86 until selectively deactivating the secondary anchor unit 8. If any of the secondary anchor performance parameters fall outside a predetermined range, the electronic section 2 will configure the radial drilling toolstring to the safe configuration 16.

A step 232 comprises activating the radial drill unit 7 to drill the radial hole 92. A step 234 comprises continuously checking and monitoring the radial drill unit performance parameters provided by the radial drill unit sensors 761, 762, 763, 764. If any of these radial drill unit performance parameters fall outside a predetermined range, the electronic section 2 configures the radial drilling toolstring 1 to the safe configuration 16.

A step 236 comprises deactivating the radial drill unit 7 and configuring it to the retracted configuration 78. A step 238 comprises checking the performance parameters of the radial drill unit to ensure that the drill bit 72 is fully retracted.

A step 240 comprises deactivating the secondary anchor unit 8. A step 242 comprises checking the secondary anchor performance parameters of the secondary anchor unit 8 to ensure that it is in the deactivated configuration 184.

A step 244 comprises checking if a subsequent radial hole is programmed. If a subsequent radial hole 92 is planned, the step 210 and any applicable subsequent steps are performed.

If no subsequent radial hole 92 is planned, a step 250 is performed, which comprises informing the operator that the sequence of actions 200 is complete.

FIG. 4 shows an alternative embodiment of a radial drilling toolstring 1′, which is connected to the surface via the wireline 99. The alternative embodiment of the radial drilling toolstring 1′ comprises the electronic section 2, the HPU 4, the primary anchor unit 3, the orientation tool 5, the secondary anchor unit 8, and the radial drill unit 7. Compared to the radial drilling toolstring 1 depicted in FIGS. 1a-1d, the alternative embodiment of the radial drilling toolstring 1′ is both shorter and less complex. A shorter toolstring may be safely sluiced into the wellbore 90 through a shorter lubricator (not shown).

The alternative embodiment of the radial drilling toolstring 1′ may be used for operations where gravity and/or an elongated flexible member, like the wireline 99, may propel it to the desired position. In some operations, it may only be necessary to drill a single radial hole 92 or the plurality radial holes 92 at one location along the wellbore 90. Alternatively, the wireline 99 and gravity may be used to reposition the radial drill unit 7 between subsequent locations along the wellbore 90 for drilling the radial holes 92.

The alternative embodiment of the radial drilling toolstring 1′ may be defined as a single tool comprising integrated devices.

FIG. 5 shows an alternative method for drilling one or more radial holes 92 in the wellbore wall 91 using the alternative embodiment of the radial drilling toolstring 1′. However, the radial drilling toolstring 1 shown in FIGS. 1a-1d may also be used. This alternative method includes step 204, which comprises displacing the radial drilling toolstring 1 or 1′ using gravity and the wireline 99. The alternative method also comprises steps 202, 205, 206, 208, 218, 220, 222, 224, 226, 228, 230, 231, 232, 234, 236, 238, 240, 242, 244, and 250, which have already been described in relation to FIG. 3 and will not be further elaborated here.

The illustrated embodiments are for illustrative purposes only. A person skilled in the art would be able to rearrange the devices forming the radial drilling toolstring 1 without departing from the scope of the invention. For instance, the primary anchor unit 3 may be substituted with the tractor 9, as both tools provide anchoring between the internal wellbore wall 91 and the radial drilling toolstring 1. The orientation tool 5 and the linear actuator 6 may exchange positions, and the secondary anchor unit 8 may be positioned at an opposite end of the radial unit 7 compared to the positions shown in the figures. This flexibility allows for customization based on specific requirements or constraints

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. A method for drilling a radial hole in a wellbore wall, the method comprising the steps of providing a radial drilling toolstring connected to a surface via an elongated flexible member, the radial drilling toolstring comprises an electronic section, an anchoring portion comprising a primary anchor unit, a drilling portion comprising a radial drill unit, the radial drilling toolstring forms a longitudinal axis, the radial drill unit is adapted to rotate a drill bit and to displace and retract the drill bit in a radial direction in relation to the longitudinal axis, the electronic section is programmable via a graphical user interface (GUI) and adapted for controlling the radial drilling toolstring to drill the radial hole in the wellbore wall, the GUI comprises visual displays;
positioning the radial drilling toolstring at a desired position within the wellbore;
programming the electronic section with a sequence of actions for the drilling of the radial hole; and
activating the electronic section, which in turn:
activates the primary anchor unit to anchor the radial drilling toolstring to the wellbore wall;
activates the radial drill unit such that the drill bit starts rotating and radially displaces the drill bit to drill the radial hole in the wellbore wall; and
upon completing drilling the radial hole deactivates the radial drill unit such that the drill bit is retracting into the radial drill unit and the drill bit stops rotating.

2. The method according to claim 1, wherein the radial drilling toolstring comprises at least one of a primary anchor sensor and a radial drill unit sensor for measuring a primary anchor performance parameter and/or a radial drill unit performance parameter, respectively.

3. The method according to claim 2, wherein the method comprises the step of:
the electronic section performing an automated check during the sequence of actions, the automated check uses at least one of the primary anchor performance parameter and/or a radial drill unit performance parameter.

4. The method according to claim 3, wherein the automated check is performed after at least one of the following actions:
activating the primary anchor unit;
starting rotation of the drill bit;
displacing the drill bit in the radial direction;
retracting the drill bit into the drill unit;
stopping rotation of the drill bit; and
deactivating the primary anchor unit.

5. The method according to claim 1, wherein the radial drilling toolstring comprises an orientation tool adapted to be controlled by the electronic section, the orientation tool is rigidly connected to the anchoring portion in one end and rigidly connected to the drilling portion in an opposite end, the orientation tool, when activated, is adapted to rotate the drilling portion around the longitudinal axis relative to the anchoring portion, and including orienting the drilling portion in relation to the anchoring portion.

6. The method according to claim 5, wherein the radial drilling toolstring comprises an orientation tool sensor for measuring an orientation tool performance parameter.

7. The method according to claim 6, further comprising the step of:
the electronic section performing an automated check during the sequence of actions using the orientation tool performance parameter, the automated check is performed at least one of prior to activating the orientation tool, while the orientation tool is activated, and after deactivating the orientation tool.

8. The method according to claim 6, further comprising the step of:
orienting the drilling portion such that the drill bit is oriented to a programmed orientation in relation to the wellbore before drilling the radial hole in the wellbore wall.

9. The method according to of claim 6, wherein the method comprises the steps of:
the electronic section comparing a programmed orientation of the drill bit and a measured orientation of the drill bit;
the electronic section using an iterative loop to orient the drill bit to the programmed orientation, and if programmed orientation, during orientation, is overshoot or undershoot, the iterative loop uses a measured overshoot or undershoot value between the programmed orientation and the measured orientation during a subsequent attempt to orient the drill bit to the programmed orientation.

10. The method according to claim 1, wherein the radial drilling toolstring comprises a secondary anchor unit within the drilling portion, and the method comprises setting the secondary anchor unit prior to drilling the radial hole.

11. The method according to claim 10, wherein the radial drilling toolstring comprises a secondary anchor sensor, and including the electronic section performing an automated check during the sequence of actions using the secondary anchor sensor for measuring a secondary anchor performance parameter, the automated check is performed at least one of prior to activating the secondary anchor unit, while the secondary anchor unit is activated, and after deactivating the secondary anchor unit.

12. The method according to claim 1, wherein the radial drilling toolstring comprises a linear actuator, the linear actuator is adapted to move the drilling portion along the longitudinal axis in relation to the anchoring portion and comprises a linear actuator sensor, and including displacing the drilling portion in relation to the anchoring portion, the electronic section performing an automated check during the sequence of actions using the linear actuator sensor for measuring a linear actuator performance parameter, the automated check is performed at least one of prior to activating the linear actuator, while the linear actuator is activated, and after deactivating the linear actuator.

13. The method according to claim 2, wherein the primary anchor sensor,the radial drill unit sensor, an orientation sensor, an linear actuator sensor and the a secondary anchor sensor each comprises at least one of an electric sensor, an electronic nodecard, a motor controller, and a hydraulic sensor.

14. The method according to claim 3, wherein the electronics section provides an operator with a status of the automated check(s) via the visual display in the GUI and stops the sequence of actions if any performance parameter is not within a predetermined limit or range during an action.

15. The method according to claim 1, wherein the method comprises the steps of:
programming the electronic section to drill at least one subsequent radial hole at a subsequent drill bit position relative to the radial hole; and
activating the electric section which in turn:
positions the drill bit to the subsequent drill bit position; and
drilling the subsequent radial hole.

16. The method according to claim 1, wherein the radial drilling toolstring comprises a propulsion device, and the method comprises moving the radial drilling toolstring to a deviated part of the wellbore using the propulsion device.

17. The method according to claim 16, further comprising the step of:
providing, through the visual display in the GUI, the orientation of the drill bit in relation to the deviated wellbore and a high side therein.

18. The method according to claim 1 any one of the preceding claims, wherein the method comprises the step of:
programming the electronic section with the sequence of actions where the electronic section, through the GUI and the visual displays, provides information to an operator of at least one of a planned action, a currently ongoing action, and a completed action.

19. The method according to claim 1, wherein the electronic section is preprogramed to displace and retract the drill bit in a programmed sequence.

20. The method according to claim 1, wherein the method comprises the step of:
programming the electronic section to displace the drill bit out to a specific distance in the radial direction.

21. The method according to claim 1, wherein the electronic section monitors a drill bit performance parameter.

22. The method according to claim 1, wherein the GUI provides an operator with a “Stop drilling” visual button in the GUI, the “Stop drilling” button is adapted to program the electronic section with a stop-drilling sequence of actions-to deactivate the radial drill unit such that the drill bit is retracted to a retracted configuration and rotation of the drill bit is stopped while at least the primary anchor unit remains active.

23. The method according to claim 5, wherein the orientation tool is adapted to controllably orient the radial drill unit in 360 degrees around the longitudinal axis.

24. A radial drilling toolstring for drilling a radial hole in a wellbore wall, the radial drilling toolstring is adapted to connect to a surface via an elongated flexible member, the radial drilling toolstring forms a longitudinal axis, the radial drilling tool string comprising:
the radial drilling toolstring comprises an electronic section, an anchoring portion comprising a primary anchor unit, a drilling portion comprising a radial drill unit;
the radial drill unit is adapted to rotate a drill bit and to displace and retract the drill bit in a radial direction in relation to the longitudinal axis;
the electronic section is programmable with a sequence of actions via a graphical user interface (GUI) and adapted for controlling the radial drilling toolstring to drill the radial hole in the wellbore wall;
the electronic section being adapted to perform an automated check of a primary anchor performance parameter while performing the sequence of actions and either continue or stop the sequence of actions if the primary anchor performance parameter does not meet set ranges or limits; and
a primary anchor sensor is connected to the primary anchor unit for measuring the primary anchor performance parameter.

25. The radial drilling toolstring according to claim 24, wherein the radial drilling toolstring comprises at least two radial drill unit sensors connected to the radial drill unit for measuring a drill unit performance parameter.

26. The radial drilling toolstring according to claim 24, wherein the radial drilling toolstring comprises an orientation tool adapted to be controlled by the electronic section, the orientation tool is rigidly connected to the anchoring portion in one end and rigidly connected to the drilling portion in an opposite end, when activated, the orientation tool is adapted to rotate the drilling portion (14) around the longitudinal axis relative to the anchoring portion.

27. The radial drilling toolstring according to claim 26, wherein the radial drilling toolstring comprises an orientation tool sensor for measuring an orientation tool performance parameter.

28. The radial drilling toolstring according to claim 24, wherein the radial drilling toolstring comprises a secondary anchor unit rigidly connected in the drilling portion, the secondary anchor unit is adapted to be controlled by the electronic section.

29. The radial drilling toolstring according to claim 28, wherein the radial drilling toolstring comprises a secondary anchor sensor for measuring a secondary anchor performance parameter.

30. The radial drilling toolstring according to any one of claim 24, wherein the radial drilling toolstring comprises a linear actuator adapted to be controlled by the electronic section, the linear actuator is adapted to move the drilling portion along the longitudinal axis in relation to the anchoring portion.

31. The radial drilling toolstring according to claim 30, wherein the radial drilling toolstring comprises a linear actuator sensor for measuring a linear actuator performance parameter.
